(19) United States
(12) Patent Application Publication
(10) Pub. No.: US 2016/0153591 A1
(43) Pub. Date: Jun. 2, 2016

(54) TUBES AND METHODS OF PRODUCTION AND USE THEREOF

(71) Applicants: Michael Fonfara, Chicopee, MA (US); Stephanie Trittschuh, Sunderland, MA (US); Richard Martini, Southampton, MA (US); Gregory P. Rooke, Springfield, MA (US)

(72) Inventors: Michael Fonfara, Chicopee, MA (US); Stephanie Trittschuh, Sunderland, MA (US); Arthur Bessette, Belchertown, MA (US); Richard Martini, Southampton, MA (US); Gregory P. Rooke, Springfield, MA (US)

(21) Appl. No.: 14/398,295

(22) PCT Filed: Jul. 10, 2012
(86) PCT No.: PCT/US2012/046053

§ 371 Date: Aug. 28, 2015

Related U.S. Application Data
(60) Provisional application No. 61/642,181, filed on May 3, 2012.
(60) Provisional application No. 61/642,172, filed on May 3, 2012.

(51) Int. Cl. F16L 11/12; B32B 5/02; F16L 11/24; B32B 27/36; B29C 65/02; B29C 65/00; B32B 1/08; B32B 27/12

(52) U.S. Cl. CPC F16L 11/12; B32B 1/08; B32B 5/02; B32B 27/12; B32B 27/36; B29C 65/02; B29C 66/532; F16L 11/24; B32B 2250/02; B32B 2262/101; B32B 2262/0276; B32B 2262/0269; B32B 2597/00; B32B 2605/00; B29K 2627/18

(57) ABSTRACT

A tube including a PTFE tube and a jacket circumferentially surrounding the PTFE tube, and method of producing same. The jacket is formed from a plurality of plaits of fiberglass lace. The fiberglass lace includes PTFE. A method of producing the tube includes providing a PTFE tube and forming a jacket by circumferentially wrapping a plurality of plaits of fiberglass lace around the PTFE tube. The fiberglass lace includes PTFE. A method of using the tube includes providing a tube as described herein and coupling one or more ends of the tube to one or more devices.

### CROSS-REFERENCE TO RELATED APPLICATIONS

This application claims priority to U.S. Provisional Patent Application Ser. Nos. 61/642,172 and 61/642,181, both filed on May 3, 2012. The entire contents of each of these applications is hereby incorporated by reference herein.

### BACKGROUND

Tubing is used to transport variety of fluids in various applications. Despite decades of research, there remains an unmet need for tubing that is resistant to chemically aggressive fluids, capable of withstanding vibration, pressures, and temperatures found in automobile and aircraft engines, and cost-effective.

### SUMMARY OF THE INVENTION

One aspect of the invention provides a tube including a PTFE tube and a jacket circumferentially surrounding the PTFE tube. The jacket is formed from a plurality of plaits of fiberglass lace. The fiberglass lace includes PTFE.

This aspect of the invention can include a variety of embodiments. The jacket can be a braided jacket. The jacket can be sintered to the PTFE tube. The fiberglass lace can be formed from a plurality of strands of PTFE-coated fiberglass. Each of the plurality of plaits can be coated with PTFE after braiding.

The plurality of plaits can lie substantially flat with respect to longitudinal axis of the tube.

One or more of the plaits can include one or more reinforcing strands. The one or more reinforcing strands can be aramids. The one or more reinforcing strands can be para-aramids. The one or more reinforcing strands can be aromatic polyesters. One or more of the plaits can have a ratio of fiberglass strands to reinforcing strands between 1:1 and 20:1. One or more of the plaits can have a ratio of fiberglass strands to reinforcing strands of 7:1.

The PTFE tube can have an orientation index between 0.9 and 1.0.

An innermost portion of the PTFE tube can be conductive. An innermost 10% of the PTFE tube can contain between about 0.5% to about 2.5% conductive particles by weight. The innermost 10% of the PTFE tube can contain between about 1.5% conductive particles by weight.

The fiberglass lace can include conductive particles. The tube can be dipped in a dispersion of conductive particles.

The conductive particles can be carbon black.

The fiberglass can be S-Glass. The fiberglass can be E-Glass.

Another aspect of the invention provides a method of producing a tube. The method includes: providing a PTFE tube and forming a jacket by circumferentially wrapping a plurality of plaits of fiberglass lace around the PTFE tube. The fiberglass lace includes PTFE.

This aspect of the invention can have a variety of embodiments. The forming step can include braiding the plurality of plaits around the PTFE tube. The fiberglass lace can be formed from a plurality of strands of PTFE-coated fiberglass. Each of the plurality of plaits can be coated with PTFE after braiding.

The PTFE tube can be formed by extrusion. The PTFE tube can be formed by vertical extrusion.

The method can further include sintering the tube to bond the PTFE tube to the braided jacket. The sintering step can include introducing the tube into an oven so that the tube is heated to between about 700° F. and about 725° F. The tube can be exposed to the oven for a sufficient period of time to hold the tube at a temperature between about 700° F. and about 725° F. for about 3 minutes.

The method can further include dipping the tube in a dispersion of conductive particles.

Another aspect of the invention provides a tube prepared by any of the methods described herein.

Another aspect of the invention provides a method of using a tube. The method includes: providing a tube as described herein and coupling one or more ends of the tube to one or more devices.

### BRIEF DESCRIPTION OF THE DRAWINGS

For a fuller understanding of the nature and desired objects of the present invention, reference is made to the following detailed description taken in conjunction with the accompanying drawing FIGS. wherein like reference characters denote corresponding parts throughout the several views and wherein:

FIG. 1 depicts a tube according to one embodiment of the invention;

FIGS. 2A and 2B depict a billet and an extruded tube having an inner conductive region, respectively;

FIG. 3 depicts a method of producing a tube according to an embodiment of the invention;

FIG. 4 depicts a method of using a tube according to an embodiment of the invention;

FIG. 5A provides a photograph of a cross-section of a wall of a tube according to an embodiment of the invention; and

FIG. 5B provides a photograph of the braided jacket of a tube according to an embodiment of the invention.

### DEFINITIONS

The instant invention is most clearly understood with reference to the following definitions:

As used herein, the singular form “a, ” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them under U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

### DETAILED DESCRIPTION OF THE INVENTION

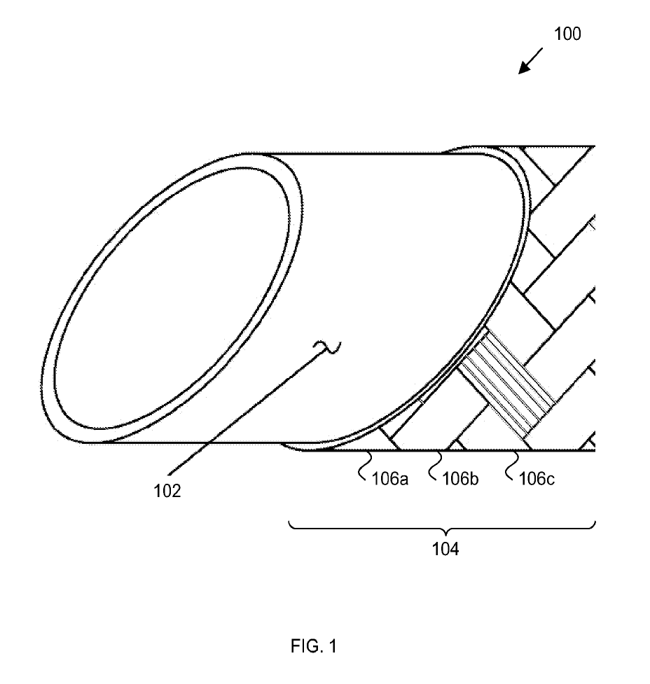

Referring now to FIG. 1, a length of tubing 100 according to one embodiment of the invention is provided. Tubing 100 includes an inner tube 102 and a jacket 104 circumferentially surrounding the inner tube 102.

Inner tube 102 can be composed of a polymer, for example, a fluoropolymer such as polytetrafluoroethylene (PTFE). In some embodiments, the inner tube is completely or partially conductive. For example, an innermost portion of the inner tube 102 (i.e., the inner surface adjacent to a longitudinal axis of the inner tube 102) can be conductive. The thickness of this innermost portion can be defined as a percentage of the thickness of the inner tube 102 can, for example, an innermost 5%, 10%, 15%, 20%, 25%, and the like. Inner tube 102 or a portion thereof can be rendered conductive by the incorporation of metal particles (e.g., copper, aluminum, gold, silver, nickel, and the like), carbon black, carbon fibers, or other conductive additives.

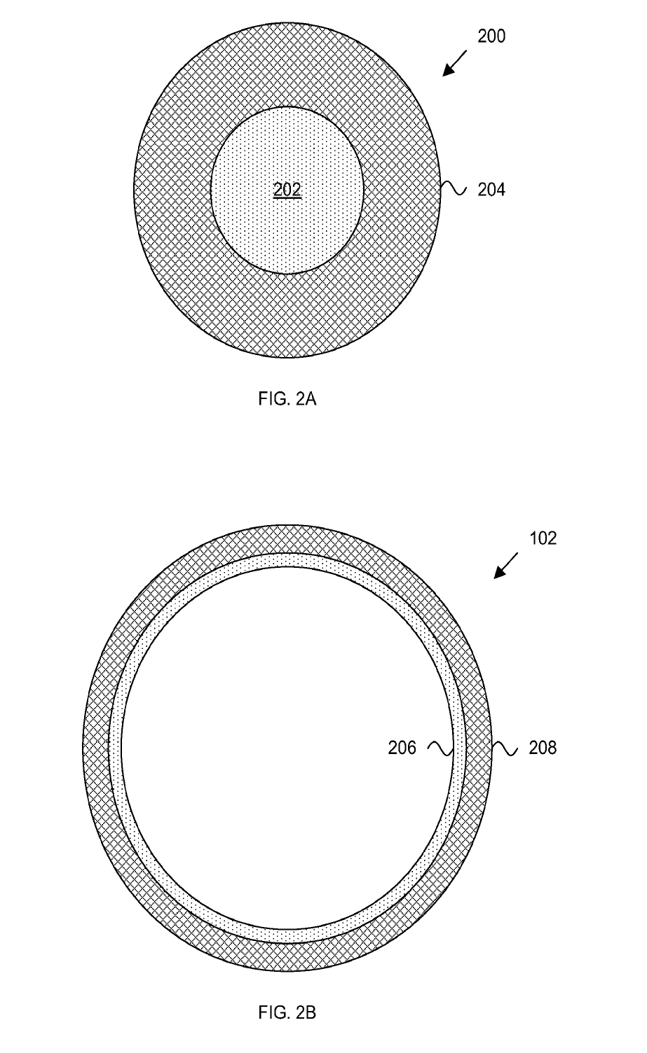

Referring to FIGS. 2A and 2B, an inner tube 102 having an inner conductive region 206 can be formed by extruding a billet 200 having an inner core of a conductive polymer 202 and an outer ring of non-conductive polymer 204 through a die. The resulting inner tube 102 has a conductive innermost region 206 composed of the conductive polymer 202 and an outermost region 208 composed of the non-conductive polymer. Although a line appears between the innermost region 206 and the outermost region 208 appears in FIG. 2B, there may not be a clear division between the regions. For example, the thickness of the innermost region may vary and/or the conductivity of the polymer may gradually decrease at the boundary between the innermost region 206 and the outermost region 208.

The conductivity of the innermost region 206 can be controlled by varying the amount of conductive particles added to the polymer. In some embodiments, the innermost region 206 contains between about 0.5% and about 2.5% conductive particles by weight, between about 1.5% and about 2.5% conductive particles by weight, and the like.

The inner tube can, in some embodiments, have a high orientation index, which is a measure of the degree of orientation of the PTFE chains in the longitudinal direction versus that of the transverse direction. An orientation index of zero (0) means that the PTFE chains are randomly oriented. An orientation index of one (1) means that all of the PTFE chains are oriented in the longitudinal direction.

The inner tube 102 can be completely formed and/or cured before the jacket 104 is applied over the inner tube 102.

Jacket 104 can be formed from a plurality of plaits 106 of fiberglass lace. The fiberglass lace, in turn, can incorporate PTFE. Suitable fiberglass lace is available under the A-A-52083 (Type IV) specification from a variety of sources including Breyden Products, Inc. of Columbia City, Ind.; Western Filament, Inc. of Grand Junction, Colo.; and W.F. Lake Corp. of Glens Falls, N.Y.

In some embodiments, the underlying fiberglass strands include of E-glass or S-glass. E-glass and S-glass are widely available from a variety of source. Generally speaking, E-glass is understood to refer to alumina-calcium-borosilicate glasses used as a general purpose reinforcement where strength and high electrical resistivity are desired, while S-glass is understood to refer to magnesium aluminosilicate glasses used for textile substrates or reinforcement in composite structural applications that require high strength, modulus, and durability under conditions of extreme temperature or corrosive environments. A variety of other types of fiberglass can be used including AR-glass, C-glass, D-glass, E-CR-glass, R-glass, and the like.

In some embodiments, the jacket 104 is braided as depicted in FIG. 1. In other embodiments, the jacket is formed by wrapping fiberglass plaits in a helical manner.

PTFE can be incorporated into the plaits 106 in a variety of manners. In one embodiments, each plait 106 is formed from a plurality of fiberglass strands, each of which individually coated with PTFE prior to braiding. In another embodiment, the braided plait 106 is dipped in PTFE to coat the braided plait 106.

Each plait 106 can have a substantially rectangular cross-section. That is, each plait 106 can have a width substantially greater than a height. In such an embodiment, the plaits 106 can be arranged in the braided jacket such that the wider side of the plaits 106 contacted inner tube 102. Such an arrangement minimizes the thickness of braided jacket 104 and provides more structural support to inner tube 102.

Each plait 106 can be formed from a plurality of individual strands of fiberglass. For example, each plait 106 can be formed from between 5 and 19 strands.

One or more reinforcing strands can be incorporated one or more of the plaits 106. For example, one or more aramid, para-aramid, or aromatic polyester strands can be braided along with the fiberglass strands. Suitable aramids and para-aramids are sold under the KEVLAR® brand by E. I. du Pont de Nemours and Company of Wilmington, Del., under the TECHNORA® brand by Teijin Limited of Osaka, Japan, and under the TWARON® brand by Teijin Aramid B. V. of Arnhem, The Netherlands. Suitable aromatic polyesters are available under the VECTRAN® and VECTRAN® EX brands from Kuraray America, Inc. of Fort Mill, S.C. The ratio of fiberglass strands to reinforcing strands can, for example, be between 1:1 and 20:1.

The jacket 104 can be conductive. For example, the jacket 104 can include a plurality of conductive particles such as metal particles (e.g., copper, aluminum, gold, silver, nickel, and the like), carbon black, carbon fibers, or other conductive additives. Such particles can be present in the individual strands of fiberglass, applied to the fiberglass plaits 106, and/or applied to the jacket 104 after formation. For example, any of the strands, plaits 106, or jacket 104 can be dipped in a dispersion of conductive particles, which are then retained.

The jacket 104 can be sintered to the inner tube 102 to provide structural stability that prevents the inner tube 102 from collapsing, deforming, or bursting as will be discussed in greater detail below.

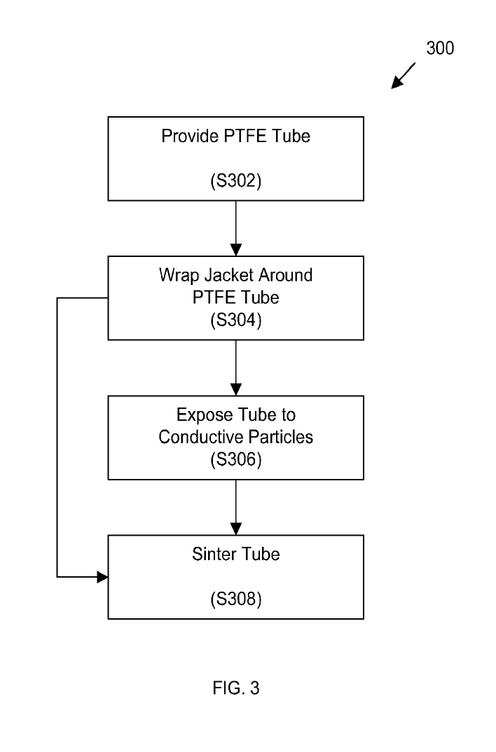

Referring now to FIG. 3, a method 300 of producing a tube according to an embodiment of the invention is provided.

In step S302, a PTFE tube is provided. The PTFE tube can be fabricated or can be obtained from a variety of sources. In some embodiments, the PTFE tube is formed by extrusion. Advantageously, PTFE tubes can be formed by vertical extrusion, in which the tube is extruded downward through a die (instead of the usual horizontal extrusion) in order to produce a tube with a high orientation index as discussed herein. Suitable vertically-extruded PTFE tubes are available from Titeflex Corporation of Springfield, Mass. Alternatively, the PTFE tube can be annealed (e.g., while hanging vertically) to increase the orientation index. This annealing step can be performed prior to the braiding step.

In step S304, a jacket is circumferentially wrapped around the PTFE tube. In some embodiments, the jacket is a braided. In other embodiments the jacket is helically wrapped. The jacket can be formed from a plurality of plaits of fiberglass lace using standard braiding and rope making techniques and equipment. As discussed above, the fiberglass lace can include PTFE and/or one or more reinforcing strands.

In step S306, the assembled tube is optionally exposed to a dispersion of conductive particles to impart a conductive property on the jacket.

In step S308, the assembled tube is optionally sintered to bond the PTFE tube to the braided jacket. The sintering step can include introducing the tube into an oven so that the tube is heated to between about 700° F. and about 725° F. The speed, length, and/or temperature of the oven can be controlled so that the tube is held at this temperature from between about 2 minutes and about 4 minutes (e.g., about 3 minutes).

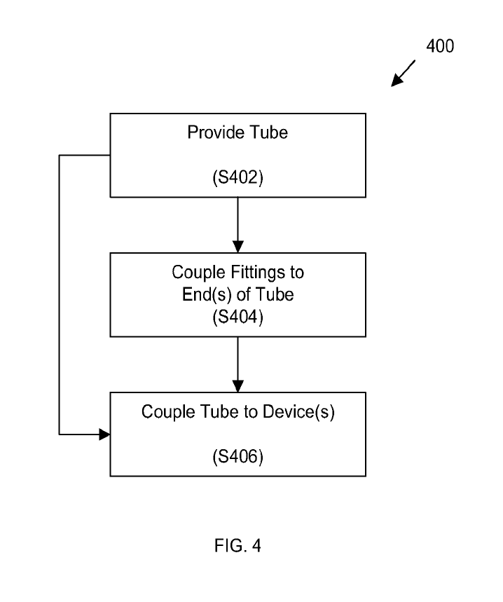

Referring now to FIG. 4, a method 400 of using a tube as described herein is provided.

In step S402, a tube is provided. The tube can be of the types described

herein.

In step S404, one or more fittings can be coupled with one or more ends of the tube. The fittings can, for example, be of conventional types used in the automotive and aerospace industries.

In step S406, one or more ends of the tube are coupled to one or more devices. For example, a first end of a tube can be connected to a fuel source (e.g., a fuel tank or a fuel pump) while a second end of the tube is connected to a fuel sink (e.g., a fuel pump, a carburetor, or a fuel injector). In another example, a first end of the tube can be connected to a braking master cylinder and a second end of the tube can be connected to a braking slave cylinder. In still another example, a first end of the tube can be connected to an engine and a second end of the tube can be connected to a radiator.

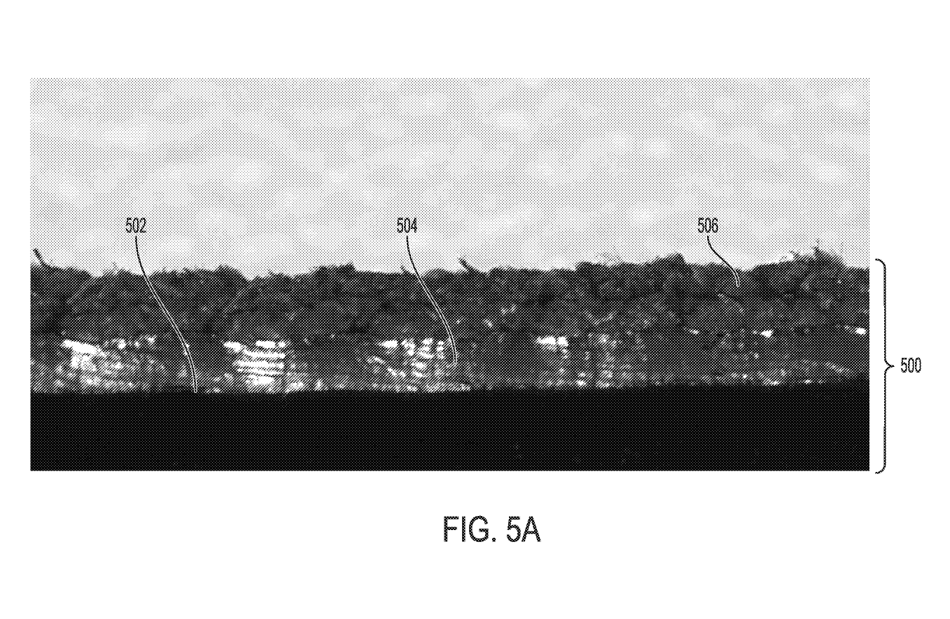

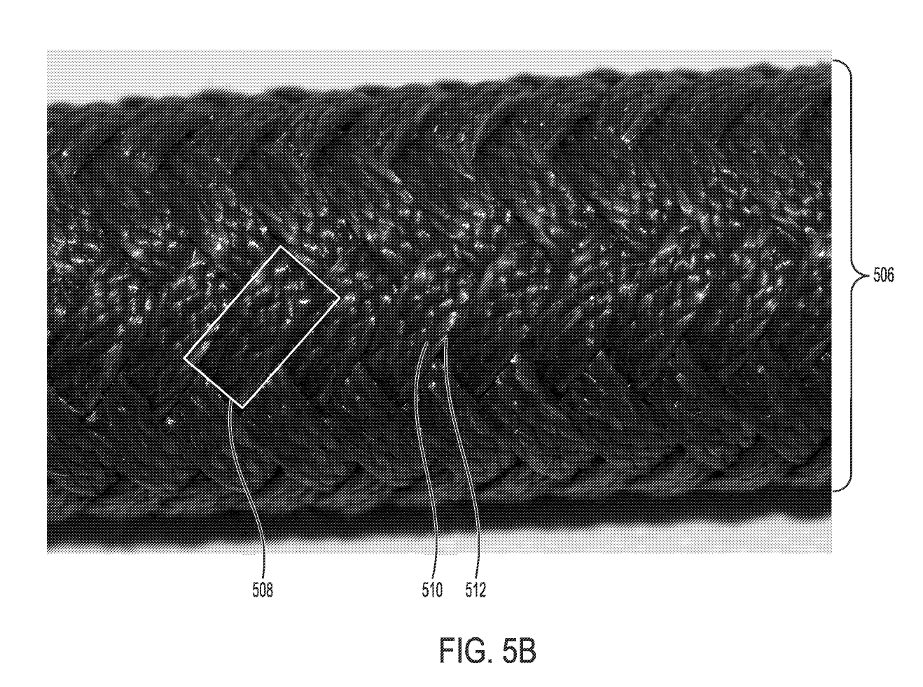

Referring now to FIGS. 5A and 5B, cross-sectional views and exterior views are provided of a tube 500 according to an embodiment of invention.

FIG. 5A provides a photograph of a cross-section a wall of the tube 500. The tube includes (moving outward from a central axis) a conductive PTFE layer 502 surrounded by a PTFE inner core layer 504 and further surrounded by a braided jacket 506.

FIG. 5B provides a photograph of the braided jacket 506 of the tube 500. Although the depicted tube 500 has a dark pigment, individual plaits 508 of fiberglass lace are visible and an exemplary plait 508 is called out by a white rectangle. Within the plaits 508 of fiberglass lace, fiberglass strands 510 and aramid strands 512 are visible. The fiberglass strands 510 are darker than the aramid strands 512.

### EQUIVALENTS

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### INCORPORATION BY REFERENCE

The entire contents of all patents, published patent applications, and other references cited herein are hereby expressly incorporated herein in their entireties by reference.

1. A tube comprising:
a PTFE tube; and
a jacket circumferentially surrounding the PTFE tube, wherein the jacket is formed from a plurality of plaits of fiberglass lace, and wherein the fiberglass lace includes PTFE.

2. The tube of claim 1, wherein the jacket is a braided jacket.

3. The tube of claim 1, wherein the jacket is sintered to the PTFE tube.

4. The tube of claim 1, wherein the fiberglass lace is formed from a plurality of strands of PTFE-coated fiberglass.

5. The tube of claim 1, wherein each of the plurality of plaits is coated with PTFE after braiding.

6. The tube of claim 1, wherein the plurality of plaits lie substantially flat with respect to longitudinal axis of the tube.

7. The tube of claim 1, wherein one or more of the plaits include one or more reinforcing strands.

8. The tube of claim 7, wherein the one or more reinforcing strands are aramids.

9. The tube of claim 7, wherein the one or more reinforcing strands are para-aramids.

10. The tube of claim 7, wherein the one or more reinforcing strands are aromatic polyesters.

11. The tube of claim 7, wherein one or more of the plaits has a ratio of fiberglass strands to reinforcing strands between 1:1 and 20:1.

12. The tube of claim 7, wherein one or more of the plaits has a ratio of fiberglass strands to reinforcing strands of 7:1.

13. The tube of claim 1, wherein the PTFE tube has an orientation index between 0.9 and 1.0.

14. The tube of claim 1, wherein an innermost portion of the PTFE tube is conductive.

15. The tube of claim 1, wherein an innermost 10% of the PTFE tube contains between about 0.5% to about 2.5% conductive particles by weight.

16. The tube of claim 31, wherein the innermost 10% of the PTFE tube contains between about 1.5% conductive particles by weight.

17. The tube of claim 1, wherein the fiberglass lace includes conductive particles.

18. The tube of claim 1, wherein the tube is dipped in a dispersion of conductive particles.

19. The tube of claim 15, wherein the conductive particles are carbon black.

20. The tube of claim 1, wherein the fiberglass is S-Glass.

21. The tube of claim 1, wherein the fiberglass is E-Glass.

22. A method of producing a tube, the method comprising:
providing a PTFE tube; and
forming a jacket by circumferentially wrapping a plurality of plaits of fiberglass lace around the PTFE tube, wherein the fiberglass lace includes PTFE.

23. The method of claim 22, wherein the forming step includes braiding the plurality of plaits around the PTFE tube.

24. The method of claim 22, wherein the fiberglass lace is formed from a plurality of strands of PTFE-coated fiberglass.

25. The method of claim 22, wherein each of the plurality of plaits is coated with PTFE after braiding.

26. The method of claim 22, wherein the PTFE tube is formed by extrusion.

27. The method of claim 22, wherein the PTFE tube is formed by vertical extrusion.

28. The method of claim 22, further comprising:
sintering the tube to bond the PTFE tube to the braided jacket.

29. The method of claim 22, wherein the sintering step includes introducing the tube into an oven so that the tube is heated to between about 700° F. and about 725° F.

30. The method of claim 29, wherein the tube is exposed to the oven for a sufficient period of time to hold the tube at a temperature between about 700° F. and about 725°F. for about 3 minutes.

31. The method of claim 22, further comprising:
dipping the tube in a dispersion of conductive particles.

32. A tube prepared by the method of claim 22.

33. A method of using a tube, the method comprising:
providing a tube of claim 1; and
coupling one or more ends of the tube to one or more devices.
